(19) United States
(12) Patent Application Publication
(10) Pub. No.: US 2007/0121683 A1
(43) Pub. Date: May 31, 2007

(54) Direct control of extinction ratio and optical modulation amplitude for fiber transmitters

(76) Inventors: Adrianus J.P. van Haasteren, Singapore (SG); Tze Wei Lim, Singapore (SG); Frank J. Flens, Singapore (SG)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/291,329

(22) Filed: Nov. 30, 2005

(51) Int. Cl. H01S 3/10

(52) U.S. Cl. 372/20

(57) ABSTRACT

A fiber optic transmitter and the method of using the fiber optic transmitter includes a laser supplied with an input current and which produces a light beam coupled into a fiber. A photodiode detects the intensity of the light beam. A processor performs the steps of sampling the waveform and detecting peaks and valleys of the detected light beam waveform. The processor also tunes the input current based on the relative values of the detected peaks and valleys of the detected light beam waveform.

### BACKGROUND OF THE INVENTION

FIG. 1 shows a typical optical coupling portion of a optical coupling portion of a fiber optic transmitter 100 of the prior art. Light from a laser 101 of the optical coupling portion of a fiber optic transmitter 100 is coupled into a fiber 103. A monitor PIN photodiode 105 detects light power generated by the laser 101 to provide feedback to the laser 101 in order to keep the light power coupled into the fiber 103 constant over the lifetime of the device and over temperature.

In the case of an FP/DFB laser, the monitor PIN photodiode 105 usually detects the light 104 emitted at the back facet of the laser as shown in FIG. 1.

Alternatively, in the case of a VCSEL, a beam splitter (not shown) is placed in the path of the laser beam, thus redirecting a fraction of light 106 to the monitor PIN photodiode 105.

The monitor PIN photodiode 105 generates a monitor PIN photodiode current 107 which is directly related to the light emitted by the laser and the amount of optical power launched into the fiber 103. The monitor PIN photodiode current 107 flows to an average light power controller 109 which tunes a bias current 111 driving the laser 101. In this way the bias current 111 driving the laser 101 is tuned using feedback provided by the monitor PIN photodiode current 107, thereby resulting in a monitor PIN photodiode current 107 that is stable over time and temperature. The average light power controller 109 includes a laser driver IC 113 which controls the bias current 111.

The targeted PIN photodiode current is usually set at the production stage. If the monitor PIN photodiode current 107 drops below this level during use, the average light power controller 109 increases the bias current 111. On the other hand, if the monitor PIN photodiode current 107 rises above this level during use, the average light power controller 109 decreases the bias current 111.

This control loop can either be fully analog, digital or a hybrid of both.

FIG. 2 shows a portion of another typical optical coupling portion of a fiber optic transmitter 200 of the prior art. In this transmitter 200, a controller 209, in addition to tuning a bias current 211, also tunes a modulation current 213 to keep the Optical Modulation Amplitude (OMA) and/or the Extinction Ratio (ER) constant over time and temperature. A temperature sensor 215 can also be inserted in the control loop to provide temperature feedback. The temperature control is usually complex because of the interdependence of the bias and modulation currents 211, 213 introduced by a laser driver IC 214. The temperature behavior of a device changes from part to part and is usually measured at the production stage by operating the module at various temperatures. The results of these measurements are then used to set the parameters of the control loop, either by placement of analog components, by setting digital parameters, or a combination of both.

The Optical Modulation Amplitude (OMA) and Extinction Ratio (ER) of a signal are important parameters that are used in specifying the performance of optical links used in digital communication systems. The OMA directly influences the system bit error ratio (BER). With an appropriate point of reference (such as average power), OMA can be directly related to ER.

For bi-level optical signaling schemes, such as nonreturn-to-zero (NRZ), only two discrete optical power levels are used. The higher level represents a binary one, and the lower level represents a zero. The symbol P1 represents the high power level and the symbol P0 represents the low power level. Using these symbols a number of useful terms and relationships can be mathematically defined.

OMA is defined as the difference between the high and low levels, which can be written mathematically as:
OMA=P1−P0.

Average power is simply the average of the two power levels, i.e.,
Pav=(P1+P0)/2.

ER represents the extinction ratio, which is the ratio between the high and low power levels, and is given by:
ER=P1/P0.

Through algebraic manipulation it can be shown that the OMA, Pav and Re are related by the equation:
OMA=2Pav(ER−1)/(ER+1).

The methodology of the prior art controls the ER/OMA indirectly using the temperature, which requires an additional tolerance margin to be put in place. For this algorithm to work, the effect of laser aging on the slope efficiency has to be estimated and “programmed” into the control loop.

It would be desirable to allow the ER/OMA to be measured directly, thereby improving yield and reducing test and laser programming time.

### SUMMARY OF THE INVENTION

A fiber optic transmitter and the method of using the fiber optic transmitter includes a laser supplied by an input current and which produces a light beam coupled into a fiber. A photodiode detects the waveform of the light beam. A processor performs the steps of sampling the waveform and detecting peaks and valleys of the detected light beam waveform. The processor also tunes the input current based on the relative values of the detected peaks and valleys of the detected light beam waveform.

### BRIEF DESCRIPTION OF THE DRAWINGS

FIG. 1 shows an optical coupling portion of a optical coupling portion of a fiber optic transmitter of the prior art which includes tuning of the laser bias current.

FIG. 2 shows an optical coupling portion of a fiber optic transmitter of the prior art which includes tuning of both the laser bias and modulation currents.

FIG. 3 shows one embodiment of an optical coupling portion of a fiber optic transmitter of the present invention using random sampling.

FIG. 4 shows another embodiment of an optical coupling portion of a fiber optic transmitter of the present invention using sample and hold.

FIG. 5 shows another embodiment of an optical coupling portion of a fiber optic transmitter of the present invention including a temperature sensor.

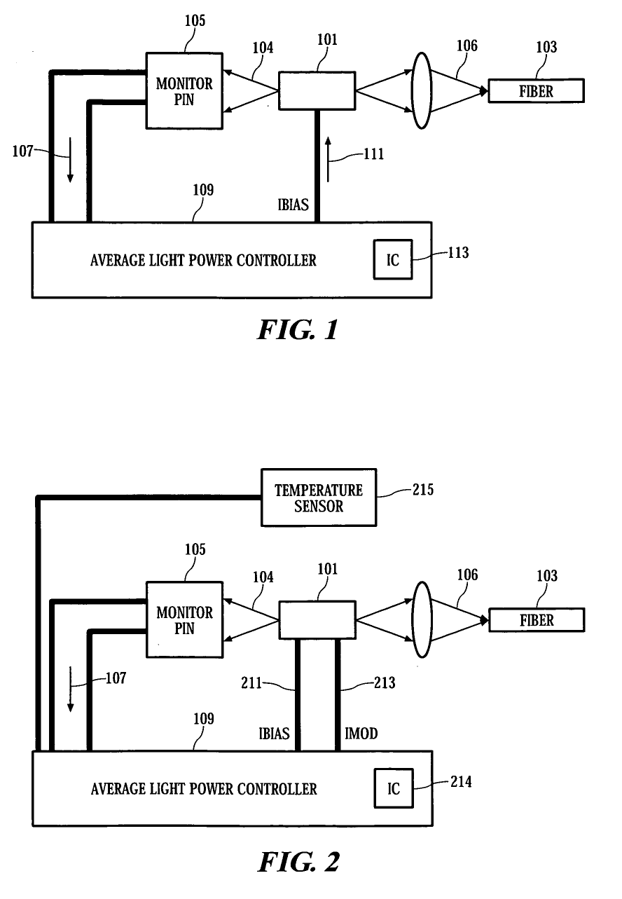

### DETAILED DESCRIPTION

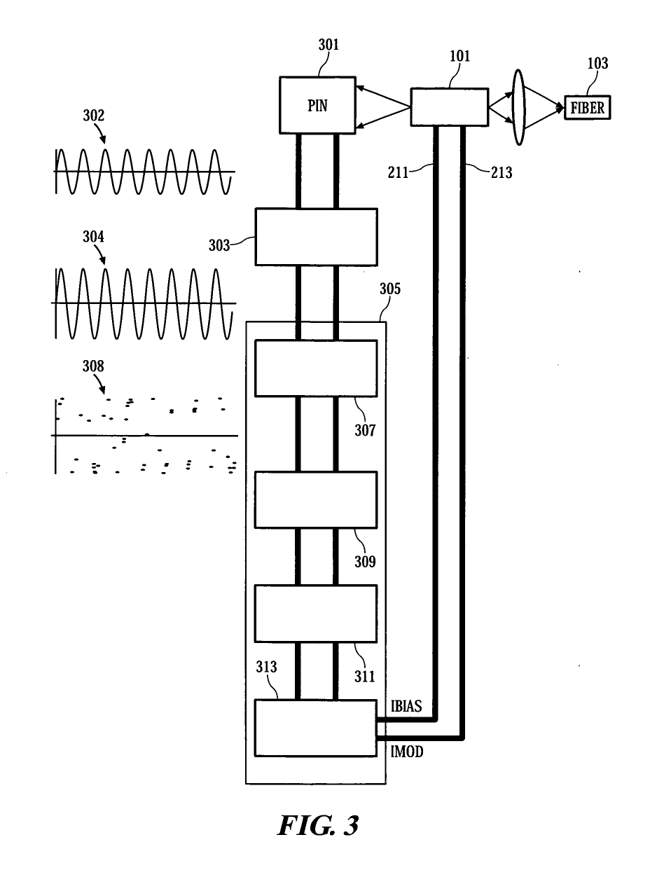

The present invention allows the ER and OMA of the fiber transmitter to be measured directly, thereby improving yield and reducing test and laser programming time. FIG. 3 shows one embodiment of an optical coupling portion of a fiber optic transmitter 300 for controlling ER and OMA. The laser 101 emits light to the fiber 103 and to a high-speed PIN photodiode 301 in the monitor path. Here “high-speed” means that the PIN photodiode is fast enough to follow the modulated light signal. This is to be compared to the low speed PIN photodiodes 105 used in the monitor path of the prior art fiber optic transmitters which average the modulated optical signal. The signal from the high-speed PIN photodiode 301 is sent to a pre-processor 303. In one embodiment, the pre-processor 303 scales/converts the monitor current from the PIN photodiode 301 into a signal that can be digitized by a digital processor 305. In the particular example of FIG. 3, the high-speed PIN photodiode 301 emits a monitor current 302, which is then scaled and converted by the pre-processor 303 into the signal 304.

The digital processor 305 samples the incoming signal 304 randomly over a time interval using an ADC (Analog-to-Digital Converter) 307. The sampling interval used is determined by the required accuracy of the ER and OMA, the average sampling interval, and the speed of the modulated signal. The sampling interval is long enough to guarantee that at least one peak and valley of the modulated signal is captured. The digitized points captured from the signal 304 are shown in plot 308. Next, the digital processor 305 uses a peak and valley detector 309 to determine the peaks and valleys from among the digitized points of the plot 308.

A calculation section 311 of the digital processor 305 then calculates the ER, OMA and/or Pav from the peaks and valleys. Taking the ratio of the peak and valley values gives the ER. Taking the difference between the peak and valley values gives the OMA. Taking the sum of the peak and valley values and dividing two gives the average level of power (Pav).

A current tuning section 313 tunes the bias current Ibias 211 and the modulation current Imod 213 based on the values calculated by the calculation section 311 to thereby drive the laser 101 and keep the Optical Modulation Amplitude (OMA) and/or the Extinction Ratio (ER) substantially constant over time and temperature.

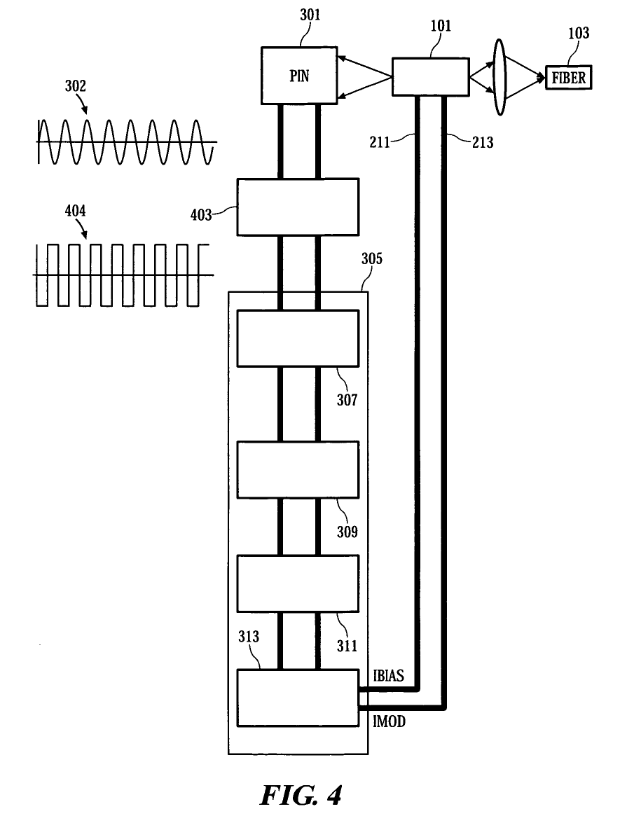

Another embodiment of the present invention is illustrated in FIG. 4. In the illustrated portion of a optical coupling portion of a fiber optic transmitter 400, the preprocessor 403 uses analog circuitry to sample and hold values of the signal peaks and valleys. These values are then sent to the digital processor 305 and processed. The sub-sections of the digital processor 305 are similar to those illustrated in the embodiment of FIG. 3. This embodiment has the advantage that no random sampling over the timer interval is required, thus speeding up the control algorithm. For this reason, the calculation of new lbias and Imod values can be reduced to simple increment or decrement steps depending on the incoming signal values.

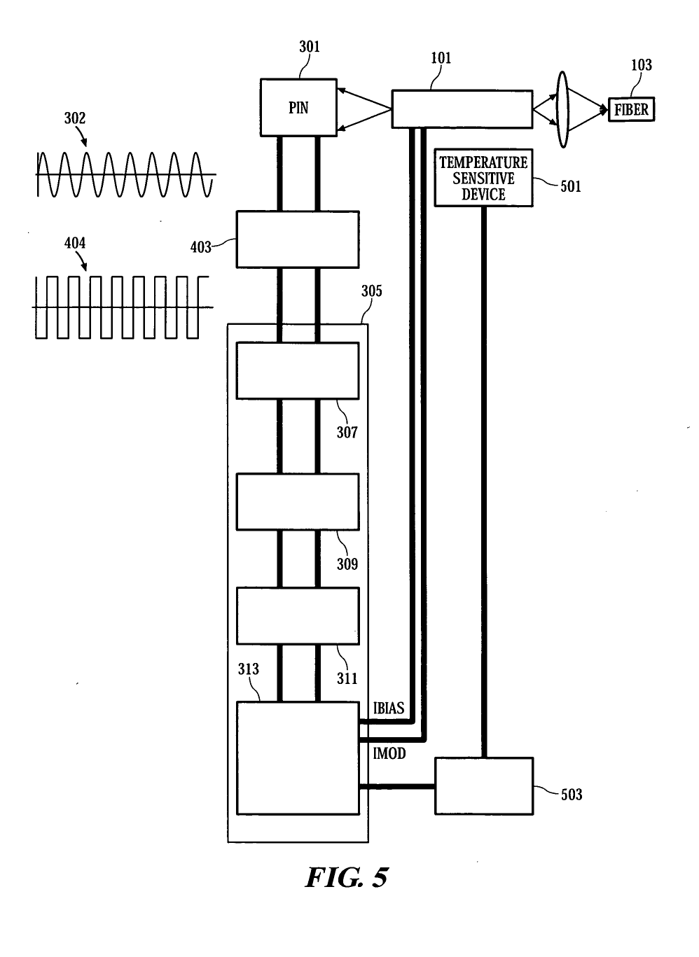

A optical coupling portion of a fiber optic transmitter 500 illustrated in FIG. 5 shows another embodiment of the optical coupling system including a temperature sensitive device or temperature sensor 501 that feeds a signal to the control logic 503 and to the digital processor 305, thereby allowing the temperature sensitivity of the optical coupling system to be directly compensated for as well. This feedback facilitates the use of plastic optical components, which exhibit a strong temperature dependent behavior as compared to conventional glass optics. The temperature 501 measures the ambient temperature.

The present invention counters any disturbing effects on the average launched power, ER and OMA introduced by temperature shifts of the laser or the optical coupling system. The changes in the laser temperature/optical elements will usually be slow (<1/300 Hz) once the product has warmed up.

Although specific embodiments of the invention have been described and illustrated, the invention is not to be limited to the specific forms or arrangements of parts so described and illustrated. The scope of the invention is to be defined by the claims appended hereto and their equivalents.

1. An optical coupling system comprising:
a laser supplied with an input current and producing a light beam which is coupled into a fiber;
a photodiode for detecting the waveform of the light beam; and
a processor for:
sampling the waveform and detecting peaks and valleys of the detected light beam waveform; and
tuning the input current based on the relative values of the detected peaks and valleys of the detected light beam waveform.

2. The optical coupling system of claim 1, wherein the input current is a bias current.

3. The optical coupling system of claim 1, wherein the input current is a modulation current.

4. The optical coupling system of claim 1, wherein the photodiode outputs a monitor current proportional to the amount of optical power launched into the fiber.

5. The optical coupling system of claim 1, wherein the processor further comprises an analog-to-digital converter for sampling the waveform randomly over a time interval to capture digitized points and wherein the processor detects peaks and valleys from the digitized points.

6. The optical coupling system of claim 5, wherein the time interval is long enough to capture at least one peak and one valley of the waveform.

7. The optical coupling system of claim 1, further comprising a preprocessor for sampling and holding values of at least one peak and one valley of the waveform.

8. The optical coupling system of claim 1, wherein the processor calculates the extinction ratio (ER) or optical modulation amplitude (OMA) of the waveform based on the values of the detected peaks and valleys and uses the calculated ER or OMA to tune the input current.

9. The optical coupling system of claim 1, further comprising a temperature sensor for detecting the ambient temperature and supplying a temperature signal representative of the ambient temperature to the processor, the processor using the temperature signal along with the detected peaks and valleys of the detected light beam waveform to tune the input current.

10. The optical coupling system of claim 1, wherein the processor tunes the input current based on the relative values of the detected peaks and valleys of the detected light beam waveform to keep the extinction ratio or optical modulation amplitude substantially constant over time and temperature.

11. A method for maintaining a substantially constant fiber optic transmitter output comprising the steps of:
coupling into a fiber a light beam produced by a laser, the laser supplied by an input current;
detecting the waveform of the light bean using a photodiode;
sampling the waveform and detecting peaks and valleys of the detected light beam waveform; and
tuning the input current based on the relative values of the detected peaks and valleys of the detected light beam waveform.

12. The method of claim 11, wherein the input current is a bias current.

13. The method of claim 11, wherein the input current is a modulation current.

14. The method of claim 11, further comprising the step of:
outputting a monitor current proportional to the amount of optical power launched into the fiber with the photodiode.

15. The method of claim 11, further comprising the steps of:
sampling the waveform randomly over a time interval with an analog-to-digital converter to capture digitized points; and
detecting peaks and valleys from the digitized points.

16. The method of claim 15, wherein the time interval is long enough to capture at least one peak and one valley of the waveform.

17. The method of claim 11, further comprising the step of sampling and holding values of at least one peak and one valley of the waveform.

18. The method of claim 11, further comprising the steps of:
calculating the extinction ratio (ER) or optical modulation amplitude (OMA) of the waveform based on the tuning the values of the detected peaks and valleys; and
tuning the input current using the calculated ER or OMA.

19. The method of claim 11, further comprising the steps of:
detecting the ambient temperature using a temperature sensor;
supplying a temperature signal representative of the ambient temperature to the processor; and
tuning the input current using the temperature signal along with the detected peaks and valleys of the detected light beam waveform.

20. The method of claim 11, further comprising the step of tuning the input current based on the relative values of the detected peaks and valleys of the detected light beam waveform.
